(19) United States
(12) Patent Application Publication
(10) Pub. No.: US 2024/0124689 A1
(43) Pub. Date: Apr. 18, 2024

(54) RESIN COMPOSITION

(71) Applicant: NAN YA PLASTICS CORPORATION, Taipei (TW)

(72) Inventors: Te-Chao Liao, Taipei (TW); Hung-Yi Chang, Taipei (TW); Chia-Lin Liu, Taipei (TW)

(73) Assignee: NAN YA PLASTICS CORPORATION, Taipei (TW)

(21) Appl. No.: 17/985,914

(22) Filed: Nov. 14, 2022

(30) Foreign Application Priority Data
Sep. 22, 2022 (TW) 111135831

(51) Int. Cl. C08L 9/06

(52) U.S. Cl. CPC C08L 9/06; C08L 2205/025; C08L 2205/03

(57) ABSTRACT

A resin composition includes resin and inorganic filler. The resin includes liquid rubber resin, polyphenylene ether resin, and a crosslinking agent. Compared to a total of 100 parts by mass of the resin, the usage amount of the inorganic filler is at least greater than or equal to 40 parts by mass.

### CROSS-REFERENCE TO RELATED APPLICATION

This application claims the priority benefit of Taiwan application serial no. 111135831, filed on Sep. 22, 2022. The entirety of the above-mentioned patent application is hereby incorporated by reference herein and made a part of this specification.

### BACKGROUND

### Technical Field

The disclosure relates to a composition, and particularly to a resin composition.

### Description of Related Art

With the rapid development of wireless networks, satellite radar, and the fifth generation (5G) communications, the power output of 5G electronic products has been continuously improved, and the related application frequencies have also increased significantly. Correspondingly, the heat dissipation requirements of materials have also increased significantly. However, the current addition ratio of the thermally conductive powder (inorganic filler) cannot be effectively increased, and the usage amount can merely reach about 10%, so the thermal conductivity cannot be effectively improved to meet stringent high-frequency transmission requirements.

### SUMMARY

The disclosure provides a resin composition, which may effectively improve the thermal conductivity of materials of the resin composition, thereby meeting the stringent high-frequency transmission requirements.

A resin composition of the disclosure includes resin and inorganic filler. The resin includes liquid rubber resin, polyphenylene ether resin, and a crosslinking agent. Compared to a total of 100 parts by mass of the resin, the usage amount of the inorganic filler is at least greater than or equal to 40 parts by mass.

In an embodiment of the disclosure, compared to a total of 100 parts by mass of the above-mentioned resin, the usage amount of the inorganic filler is between 40 parts by mass and 75 parts by mass.

In an embodiment of the disclosure, the above-mentioned inorganic filler includes silicon dioxide, aluminum oxide, silicon nitride, aluminum nitride, aluminum silicate, calcium silicate, boron nitride, silicon carbide, titanium dioxide, strontium titanate or calcium titanate.

In an embodiment of the disclosure, the above-mentioned inorganic filler at least includes different first inorganic filler and second inorganic filler.

In an embodiment of the disclosure, the above-mentioned resin includes the liquid rubber resin of which the use ratio in the resin is between 5% and 25%, the polyphenylene ether resin of which the use ratio in the resin is between 5% and 20%, and the crosslinking agent of which the use ratio in the resin is between 5% and 20%.

In an embodiment of the disclosure, the above-mentioned liquid rubber resin has 10% to 90% of 1,2-vinyl groups, 0% to 50% of styrene groups, and a molecular weight that is between 1000 and 5000.

In an embodiment of the disclosure, the above-mentioned resin composition further includes at least one selected from the group consisting of: a flame retardant, a siloxane coupling agent, and an accelerator.

In an embodiment of the disclosure, compared to a total of 100 parts by mass of the above-mentioned resin, the usage amount of the siloxane coupling agent is between 0.1 parts by mass and 5 parts by mass.

In an embodiment of the disclosure, compared to a total of 100 parts by mass of the above-mentioned resin, the usage amount of the accelerator is between 0.1 parts by mass and 5 parts by mass.

In an embodiment of the disclosure, the thermal conductivity of the resin composition is greater than or equal to 1.2 W/mK.

Based on the above, the resin of the resin composition of the disclosure includes liquid rubber resin, polyphenylene ether resin, and a crosslinking agent. By the combination of the aforementioned resin and inorganic filler, the usage amount of the inorganic filler may be at least greater than or equal to 40 parts by mass, and the inorganic filler has good compatibility with the resin. Therefore, a substrate produced by the resin composition of the disclosure may effectively improve thermal conductivity while maintaining good physical properties such as peel strength, heat resistance, water absorption, and low dielectric, so as to meet the stringent high-frequency transmission requirements.

In order to make the aforementioned features and advantages of the disclosure comprehensible, embodiments are described in detail as follows.

### DESCRIPTION OF THE EMBODIMENTS

In the embodiment, a resin composition at least includes resin and inorganic filler, and the resin includes liquid rubber resin, polyphenylene ether resin, and a crosslinking agent. In addition, through the combination of the aforementioned resin and the inorganic filler, the usage amount of the inorganic filler may be at least greater than or equal to 40 parts by mass, and the inorganic filler has good compatibility with the resin. Therefore, a substrate produced by the resin composition of the embodiment may effectively improve thermal conductivity while maintaining good physical properties such as peel strength, heat resistance, water absorption, and low dielectric, so as to meet the stringent high-frequency transmission requirements. For example, the thermal conductivity of the resin composition is greater than or equal to 1.2 W/mK, but the disclosure is not limited thereto as the thermal conductivity of the resin composition may be determined according to actual design requirements.

Further, compared to a total of 100 parts by mass of the resin, the usage amount of the inorganic filler may be between 40 parts by mass and 75 parts by mass (for example, 40 parts by mass, 45 parts by mass, 50 parts by mass, 55 parts by mass, 60 parts by mass, 65 parts by mass, 70 parts by mass, 75 parts by mass or any value within the above-mentioned 40 parts by mass to 75 parts by mass), but the disclosure is not limited thereto as the usage amount of the inorganic filler may be adjusted according to actual design requirements.

In some embodiments, the inorganic filler includes silicon dioxide, aluminum oxide, silicon nitride, aluminum nitride, aluminum silicate, calcium silicate, boron nitride, silicon carbide, titanium dioxide, strontium titanate or calcium titanate, but the disclosure is not limited thereto.

Currently, in order to improve the thermal conductivity in the resin composition, two or more types of inorganic filler are often used. However, the problems of poor water absorption and poor heat resistance are prone to occur after multiple types of inorganic filler are mixed together, resulting in a follow-up problem of insufficient strength between a copper foil and a substrate. However, in the embodiment, the inorganic filler may at least include different first inorganic filler and second inorganic filler. Through the design of the resin including the liquid rubber resin, the polyphenylene ether resin, and the crosslinking agent, the thermal conductivity may be further improved while the probability of occurrence of the problems of poor water absorption and poor heat resistance after adding at least two types of inorganic filler to the resin composition is reduced, thereby improving the reliability of a follow-up substrate. It should be noted that the disclosure does not limit the number of types of inorganic filler used. As long as at least one type of inorganic filler is used, all of which falls within the protection scope of the disclosure.

In some embodiments, the resin includes the liquid rubber resin of which the use ratio in the resin is between 5% and 25%, the polyphenylene ether resin of which the use ratio in the resin is between 5% and 20%, and the crosslinking agent of which the use ratio in the resin is between 5% and 20%, but the disclosure is not limited thereto.

In some embodiments, the liquid rubber resin may be polybutadiene and may have the following structure, wherein n=15 to 25, preferably n=16 to 22:

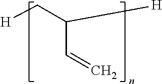

In some embodiments, the liquid rubber resin may be a polyolefin and includes, but is not limited to: a styrene-butadiene-divinylbenzene terpolymer, a styrene-butadiene-maleic anhydride terpolymer, a vinyl-polybutadiene-urethane oligomer, a styrene-butadiene copolymer, a hydrogenated styrene-butadiene copolymer, a styrene-isoprene copolymer, a hydrogenated styrene-isoprene ethylene copolymer, a hydrogenated styrene-butadiene-divinylbenzene copolymer, polybutadiene (a homopolymer of butadiene), a maleic anhydride-styrene-butadiene copolymer, a methyl styrene copolymer, or a group of combinations thereof.

In some embodiments, the liquid rubber resin has 10% to 90% 1,2-vinyl, 0% to 50% styrene, and a molecular weight that may be between 1000 and 5000 to be effectively cross-linked with other resin to improve compatibility, but the disclosure is not limited thereto.

In some embodiments, the polyphenylene ether resin is thermosetting polyphenylene ether resin, and is a composition having styrene-type polyphenylene ether and acrylic-type polyphenylene ether at the end groups. For example, the structure of the styrene-type polyphenylene ether is shown in structural formula (A):

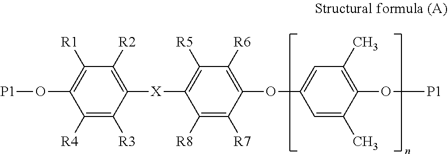

Wherein R1 to R8 may be allyl or hydrogen groups or C1 to C6 alkyl groups, or one or more selected from the above-mentioned groups, and X may be: O (oxygen atoms),

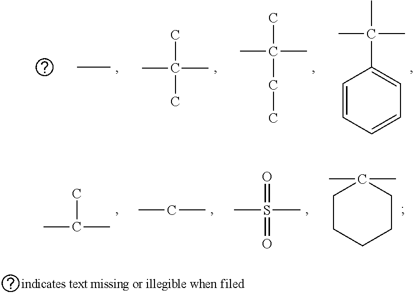

wherein P1 is styryl,

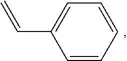

and n=an integer from 1 to 99.

The structure of acrylic-type polyphenylene ether at the end is shown in structural formula (B):

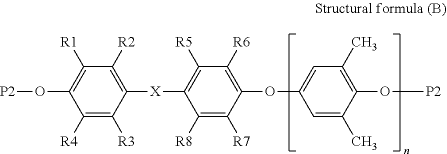

Wherein R1 to R8 may be allyl or hydrogen groups or C1 to C6 alkyl groups, or one or more selected from the above-mentioned groups. X may be: O (oxygen atoms),

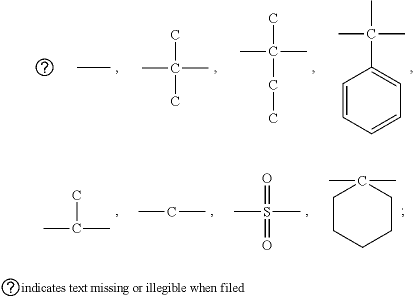

wherein P2 is

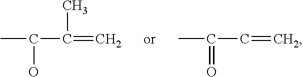

and n=an integer from 1 to 99.

Specific examples of the polyphenylene ether resin include, but are not limited to, dihydroxypolyphenylene ether resin (e.g., SA-90, available from Sabic Corporation), vinylbenzyl polyphenylene ether resin (e.g., OPE-2st, available from Mitsubishi Gas Chemical Corporation), methacrylate polyphenylene ether resin (e.g., SA-9000, available from Sabic Corporation), vinylbenzyl modified bisphenol A polyphenylene ether resin or vinyl chain extended saw phenylene ether resin. The aforementioned polyphenylene ether is preferably vinyl polyphenylene ether.

In some embodiments, the crosslinking agent is used to increase the degree of crosslinking of the thermosetting resin, adjust the rigidity and toughness of the substrate, and adjust the processability; and the type of use may be one or more combinations of 1,3,5-triallyl cyanurate (TAC), triallyl isocyanurate (TAIC), trimethylallyl isocyanurate (TMAIC), diallyl phthalate, divinylbenzene or 1,2,4-triallyl trimellitate.

In some embodiments, the resin composition further includes at least one selected from the group consisting of: a flame retardant, a siloxane coupling agent, and an accelerator. Moreover, compared to a total of 100 parts by mass of the resin, the usage amount of the siloxane coupling agent ranges from 0.1 parts by mass to 5 parts by mass (for example, 0.1 parts by mass, 0.5 parts by mass, 1 part by mass, 1.5 parts by mass, 2 parts by mass, 3 parts by mass, 4 parts by mass, 5 parts by mass, or 0.1 parts by mass to 5 parts by mass or any value within the aforementioned 0.1 parts by mass to 5 parts by mass), and the usage amount of the accelerator is between 0.1 parts by mass and 5 parts by mass (for example, 0.1 parts by mass, 0.5 parts by mass, 1 part by mass, 1.5 parts by mass, 2 parts by mass, 3 parts by mass, 4 parts by mass, 5 parts by mass, or 0.1 to 5 parts by mass or any value within the aforementioned 0.1 parts by mass to 5 parts by mass), but the disclosure is not limited thereto.

In some embodiments, the siloxane coupling agent may include, but is not limited to, a siloxane. In addition, according to the type of functional group, a siloxane may be divided into an amino silane compound, an epoxide silane compound, a vinyl silane compound, an ester silane compound, a hydroxy silane compound, an isocyanate silane compound, a methyl silane acryloyloxysilane compound, and an acryloxysilane compound, but the disclosure is not limited thereto.

In some embodiments, the accelerator includes a catalyst, and the catalyst may be dimethylimidazole, diphenylimidazole, diethyltetramethylimidazole, or benzyldimethylamine, but the disclosure is not limited thereto.

It should be noted that the resin composition of the disclosure may be processed into a prepreg and a copper foil substrate (FCCL) according to actual design requirements. Therefore, the prepreg and the FCCL produced by using the resin composition of the disclosure also have better thermal conductivity. In addition, the specific embodiments listed above are not limitations of the disclosure. As long as the resin of the resin composition includes liquid rubber resin, polyphenylene ether resin, and a crosslinking agent, and the usage amount of inorganic filler may be at least greater than or equal to 40 parts by mass by the combination of the aforementioned resin and inorganic filler, all of which falls within the protection scope of the disclosure.

The following examples and comparative examples are given to illustrate the effects of the disclosure, but the scope of claims of the disclosure is not limited to the scope of the examples.

The FCCLs produced in the respective examples and the comparative examples were evaluated according to the following method.

A dielectric constant Dk: The dielectric constant Dk at a frequency of 10 GHz was measured by a dielectric analyzer (E4991A) of Agilent Technologies.

A dielectric loss Df: The dielectric loss Df at a frequency of 10 GHz was measured by the dielectric analyzer (E4991A) of Agilent Technologies.

A glass transition temperature (° C.) was measured with a dynamic mechanical analyzer (DMA). A thermal conductivity analysis test: An interface material thermal resistance and thermal conductivity measuring instrument is used, which is in line with ASTM D5470 standard.

Peel strength (lb/in): The peel strength between a copper foil and a circuit carrier is tested.

### Examples 1 to 4, Comparative Examples 1 to 3

The resin composition shown in Table 1 was mixed with toluene to form a varnish of thermosetting resin composition. After the above-mentioned varnish was impregnated with Nanya fiberglass cloth (Nanya Plastics Co., Ltd., cloth type 1078) at room temperature, and then dried at 110° C. (an impregnation machine) for a few minutes, a prepreg with a resin content of 76 wt % was obtained. Finally, four pieces of prepreg were stacked between two 35 μm thick copper foils, maintained at a constant temperature for 20 minutes under a pressure of 25 kg/cm2 and a temperature of 85° C., then heated to 185° C. at a heating rate of 3° C./min, maintained at a constant temperature for 120 minutes, and then slowly cooled to 130° C. to obtain a 0.8 mm thick FCCL.

The physical properties of the prepared FCCL were tested, and the results are shown in Table 1. After comparing the results of Examples 1 to 4 and Comparative Examples 1 to 3 in Table 1, the following conclusions may be drawn: Compared with Comparative Example 1, Example 1 has a proportion of inorganic filler up to 40 wt %, so the thermal conductivity may reach 1.2 w/mk and above; compared with Comparative Example 2, Example 1 uses two types of inorganic filler, which may have better thermal conductivity; compared with Comparative Example 3, Example 1 uses styrene-containing liquid rubber resin, so that the peel strength may be further improved. In addition, compared with Example 1, Example 2 may further improve the glass transition temperature and the peel strength by increasing the usage amount of the accelerator; compared with Example 1, Example 3 may further improve the thermal conductivity by increasing the usage amount of filler (boron nitride); and compared with Example 1, Example 4 may further improve the peel strength by increasing the usage amount of the siloxane coupling agent. It should be noted that, compared with Comparative Examples 1 to 3, Example 1 may have already achieved better technical effects, so Examples 2 to 4 are optional technical means, and are not necessary technical means in this case.

TABLE 1

| | | | 1,2- | Molec- | | | | | Com- | Com- | Com- |
|---|---|---|---|---|---|---|---|---|---|---|---|
| | | | vinyl | ular | | | | | parative | parative | parative |
| | | Styrene | group | weight | Exam- | Exam- | Exam- | Exam- | Exam- | Exam- | Exam- |
| Composition ratio | | ( wt %) | ( wt %) | (Mn) | ple 1 | ple 2 | ple 3 | ple 4 | ple 1 | ple 2 | ple 3 |
| Liquid rubber | RICON- | 20 | 50 | 4500 | 14 wt % | 14 wt % | 14 wt % | 14 wt % | 22.75 wt % | 14 wt % | — |
| resin | 257 | | | | | | | | | | |
| | RICON- | 25 | 40 | 3200 | 14 wt % | 14 wt % | 14 wt % | 14 wt % | 22.75 wt % | 14 wt % | — |
| | 181 | | | | | | | | | | |
| | B-2000 | 0 | 90 | 2000 | — | — | — | — | — | — | 28 wt % |
| Polyphenylene | SA9000 | — | — | 2200 | 6 wt % | 6 wt % | 6 wt % | 6 wt % | 9.75 wt % | 6 wt % | 6 wt % |
| ether resin | | | | | | | | | | | |
| Crosslinking | TAIC | — | — | 350 | 6 wt % | 6 wt % | 6 wt % | 6 wt % | 9.75 wt % | 6 wt % | 6 wt % |
| agent | | | | | | | | | | | |
| Siloxane | Z6030 | — | — | — | 1 phr | 1 phr | 1 phr | 3 phr | 1 phr | 1 phr | 1 phr |
| coupling | | | | | | | | | | | |
| agent | | | | | | | | | | | |
| Accelerator | DCP | — | — | — | 1 phr | 5 phr | 1 phr | 1 phr | 1 phr | 1 phr | 1 phr |
| Inorganic | 525AR | — | — | — | 30 wt % | 20 wt % | 30 wt % | 30 wt % | 17.5 wt % | 60 wt % | 30 wt % |
| filler | V | | | | | | | | | | |
| | (silica) | | | | | | | | | | |
| | S35 | — | — | — | 30 wt % | 40 wt % | 40 wt % | 30 wt % | 17.5 wt % | — | 30 wt % |
| | (boron | | | | | | | | | | |
| | nitride) | | | | | | | | | | |

| | | | | | | | | |
|---|---|---|---|---|---|---|---|---|
| Characteristic | Dk/Df(10 GHz) | 3.60/ | 3.64/ | 3.66/ | 3.65/ | 3.54/ | 3.48/ | 3.63/ |
| | | 0.0032 | 0.0033 | 0.003 | 0.0034 | 0.0029 | 0.0025 | 0.0033 |
| | Glass transition temperature (° C.) | 211 | 231 | 213 | 205 | 204 | 216 | 218 |
| | Thermal conductivity (W/mK) | 1.32 | 1.25 | 1.41 | 1.33 | 0.85 | 0.62 | 1.21 |
| | Peel Strength (lb/inch) | 4.4 | 4.9 | 4.3 | 4.6 | 5.1 | 5.2 | 3.2 |

To sum up, the resin of the resin composition of the disclosure includes liquid rubber resin, polyphenylene ether resin, and a crosslinking agent. By the combination of the aforementioned resin and inorganic filler, the usage amount of the inorganic filler may be at least greater than or equal to 40 parts by mass, and the inorganic filler has good compatibility with the resin. Therefore, a substrate produced by the resin composition of the disclosure may effectively improve thermal conductivity while maintaining good physical properties such as peel strength, heat resistance, water absorption, and low dielectric, so as to meet the stringent high-frequency transmission requirements.

Although the disclosure has been described with reference to the above embodiments, the described embodiments are not intended to limit the disclosure. People of ordinary skill in the art may make some changes and modifications without departing from the spirit and the scope of the disclosure. Thus, the scope of the disclosure shall be subject to those defined by the attached claims.

What is claimed is:

1. A resin composition, comprising:
resin, comprising liquid rubber resin, polyphenylene ether resin, and a crosslinking agent; and
inorganic filler, and an usage amount of the inorganic filler being at least greater than or equal to 40 parts by mass compared to a total of 100 parts by mass of the resin.

2. The resin composition according to claim 1, wherein the usage amount of the inorganic filler ranges from 40 parts by mass to 75 parts by mass compared to a total of 100 parts by mass of the resin.

3. The resin composition according to claim 1, wherein the inorganic filler comprises silicon dioxide, aluminum oxide, silicon nitride, aluminum nitride, aluminum silicate, calcium silicate, boron nitride, silicon carbide, titanium dioxide, strontium titanate or calcium titanate.

4. The resin composition according to claim 1, wherein the inorganic filler comprises at least different first inorganic filler and second inorganic filler.

5. The resin composition according to claim 1, wherein the resin comprises the liquid rubber resin of which a use ratio in the resin is between 5% and 25%, the polyphenylene ether resin of which a use ratio in the resin is between 5% and 20%, and the crosslinking agent of which a use ratio in the resin is between 5% and 20%.

6. The resin composition according to claim 1, wherein the liquid rubber resin has 10% to 90% of 1,2-vinyl groups, 0% to 50% of styryl groups, and a molecular weight that is between 1000 and 5000.

7. The resin composition according to claim 1, further comprising at least one selected from a group consisting of: a flame retardant, a siloxane coupling agent, and an accelerator.

8. The resin composition according to claim 7, wherein a usage amount of the siloxane coupling agent ranges from 0.1 parts by mass to 5 parts by mass compared to a total of 100 parts by mass of the resin.

9. The resin composition according to claim 7, wherein a usage amount of the accelerator ranges from 0.1 parts by mass to 5 parts by mass compared to a total of 100 parts by mass of the resin.

10. The resin composition according to claim 1, wherein thermal conductivity of the resin composition is greater than or equal to 1.2 W/mK.
